(19) United States
(12) Patent Application Publication
(10) Pub. No.: US 2026/0155390 A1
(43) Pub. Date: Jun. 4, 2026

(54) CURRENT COLLECTOR AND BATTERY

(71) Applicant: TOYOTA JIDOSHA KABUSHIKI KAISHA, Toyota-shi (JP)

(72) Inventor: Hideaki NISHIMURA, Shizuoka-ken (JP)

(73) Assignee: TOYOTA JIDOSHA KABUSHIKI KAISHA, Toyota-shi (JP)

(21) Appl. No.: 19/290,754

(22) Filed: Aug. 5, 2025

(30) Foreign Application Priority Data
Dec. 2, 2024 (JP) 2024-209740

(51) Int. Cl. H01M 4/66; H01M 4/02; H01M 10/052

(52) U.S. Cl. CPC H01M 4/667; H01M 4/661; H01M 10/052; H01M 2004/021

(57) ABSTRACT

A current collector according to the present disclosure includes a substrate that contains elemental aluminum, and a protective layer that is formed on a side of the substrate that is in contact with an electrode active material layer. The strength of the substrate is equal to 200 MPa or higher.

### CROSS-REFERENCE TO RELATED APPLICATION

This application claims priority to Japanese Patent Application No. 2024-209740 filed on Dec. 2, 2024. The disclosure of the above-identified application, including the specification, drawings, and claims, is incorporated by reference herein in its entirety.

### BACKGROUND

### 1. Technical Field

The present disclosure relates to a current collector and a battery.

### 2. Description of Related Art

Japanese Unexamined Patent Application Publication No. 2018-116910 (JP 2018-116910 A) discloses a lithium-ion secondary battery. The lithium ion secondary battery includes a cathode current collector, a separator, an anode current collector (hereinafter also referred to as “anode”), an electrolytic solution, and a battery case. The anode has an anode precursor (hereinafter also referred to as “anode current collector”) and a coating of a conductive active material that is made of a carbon-based material, which is formed on the anode current collector (hereinafter also referred to as an “anode active material layer”). The anode current collector has an aluminum foil, and a plating film that covers the surface of the aluminum foil. The plating film is made of nickel or copper.

### SUMMARY

However, in the lithium ion battery that is disclosed in JP 2018-116910 A, there is concern that when the anode active material layer expands during charging, the anode current collector (aluminum foil) will be deformed. There also is concern that this will cause cracks in the anode active material layer, increasing resistance. Accordingly, there is demand for a current collector that can be used to form a battery in which resistance does not readily increase even when the battery is charged and then discharged (hereinafter also referred to as “charge and discharge”).

Further, there is demand for a current collector that can be used to form a battery with excellent structural efficiency. This “structural efficiency” refers to the proportion of the volume of the power generating elements that are contained in the battery, as to the volume of the battery itself.

A problem to be solved by one embodiment of the present disclosure is to provide a current collector and a battery that do not readily increase in resistance even when charged and discharged, and that can also provide a battery with excellent structural efficiency.

Measures for solving the above problem include the following aspects.
<1> A current collector, including a substrate containing elemental aluminum, and
a protective layer that is fashioned on a side of the substrate that is in contact with an electrode active material layer, in which
a breaking tensile strength of the substrate is 200 MPa or higher.
<2> The current collector according to the above <1>, in which the protective layer contains elemental nickel.
<3> The current collector according to the above <1> or <2>, in which a thickness of the protective layer is 2.0 μm or less.
<4> A battery, including the current collector according to any one of the above <1> to <3>, an anode active material layer, an electrolyte layer, a cathode active material layer, and a cathode current collector, in this order, in which
the electrode active material layer is the anode active material layer, and
reaction potential (vs. Li+/Li) of an anode active material that is contained in the anode active material layer is 0.3 V or lower.
<5> The battery according to the above <4>, in which the electrolyte layer contains a solid electrolyte.

According to one embodiment of the present disclosure, there is provided a current collector and a battery that do not readily increase in resistance even when charged and discharged, and that can also provide a battery with excellent structural efficiency.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view of a battery according to a first embodiment of the present disclosure; and

FIG. 2 is a cross-sectional view of a battery according to a second embodiment of the present disclosure.

### DETAILED DESCRIPTION OF EMBODIMENTS

In the present disclosure, numerical value ranges that are indicated using “to” indicate a range that includes numerical values written before and after the “to” as the minimum value and the maximum value, respectively.

In the present disclosure, in which numerical value ranges are described in stages, an upper limit value or a lower limit value that is described in a certain numerical value range may be replaced with an upper limit value or a lower limit value of another numerical value range that is described in stages. In the numerical value ranges that are described in the present disclosure, an upper limit value or a lower limit value that is described in a certain numerical value range may be replaced with a value that is shown in the Examples.

In the present disclosure, a combination of two or more preferred forms is considered to be a more preferred form.

In the present disclosure, when an embodiment is described with reference to drawings, the configuration of the embodiment is not limited to the configuration that is illustrated in the drawings. Also, the sizes of the components in the drawings are conceptual, and the relative relationships between the sizes of the components are not limited to these.

### (1) Current Collector

A current collector according to the present disclosure includes a substrate containing elemental aluminum (Al), and a protective layer that is formed on a side of the substrate that is in contact with an electrode active material layer. The substrate has a breaking tensile strength of 200 MPa or more.

The “substrate” is a sheet-like object. The term “electrode active material layer” refers to at least one of a cathode active material layer and an anode active material layer. The method for measuring the “breaking tensile strength” is the same as that described in the Examples.

The current collector of the present disclosure has the above configuration, and accordingly provides a current collector and a battery that do not readily exhibit increase in resistance even when charged and discharged, and that can also provide a battery with excellent structural efficiency.

This effect is presumed to be due to, but not limited to, the following reasons.

The substrate has a breaking tensile strength of 200 MPa or higher in the present disclosure. A substrate having a breaking tensile strength of 200 MPa or higher indicates that the substrate has a high level of strength. Accordingly, even when the electrode active material layer expands or contracts due to charging and discharging, the current collector does not readily deform. That is to say, the current collector according to the present disclosure can make the electrode active material layer to crack less readily. Further, in the present disclosure, a later-described “current collector thickness relative to battery resistance (%)” is relatively low. In other words, when the battery resistance is a particular battery resistance, the thickness of the current collector is relatively thin. As a result, it is presumed that the current collector of the present disclosure can be used to form a battery that is less likely to exhibit increase in resistance even when charged and discharged, and that also has excellent structural efficiency.

When an electrode active material layer is formed on one principal face side of the substrate, a protective layer may be formed, or may not be formed, on the other principal face of the substrate.

The thickness of the current collector of the present disclosure is not limited in particular, and may be 5.0 μm to 35.0 μm, may be 15.2 μm to 19.0 μm, may be 16.0 μm to 18.0 μm, or may be 16.0 μm to 17.4 μm.

The current collector of the present disclosure may be used as an anode current collector of a battery, or may be used as a cathode current collector of a battery.

### (1.1) Substrate

The substrate is not limited in particular, as long as the substrate contains elemental Al and also has a breaking tensile strength of 200 MPa or higher. Examples of the material of the substrate, from the viewpoint of improving the breaking tensile strength of the substrate, include Al—Mn based alloys (alloy numbers in 3000 series), Al—Mg based alloys (alloy numbers in 5000 series), and Al—Cu based alloys (alloy numbers in 1100 series).

The breaking tensile strength of the substrate is 200 MPa or higher, may be 200 MPa to 500 MPa, may be 200 MPa to 300 MPa, or may be 220 MPa to 270 MPa. The breaking tensile strength of the substrate can be adjusted by the material of the substrate.

The thickness of the substrate is not limited in particular, and may be 5 μm to 30 μm, or may be 10 μm to 20 μm, from the viewpoint of obtaining a battery with excellent structural efficiency.

### (1.2) Protective Layer

The protective layer may contain an elemental metal (e.g., elemental Ni, elemental Fe, elemental Cr, elemental Cu, elemental Au, Ag element, and so forth). The protective layer preferably contains elemental Ni. This allows the protective layer to impart greater strength to the current collector. The protective layer may be an electrolytic plated film or a non-electrolytic plated film.

The thickness of the protective layer is not limited in particular, but is preferably 2.0 μm or less. Setting the thickness of the protective layer to 2.0 μm or less enables the amount of the protective layer (e.g., electrolytic Ni plated film) of the current collector to be reduced, while making a battery in which the resistance increases less readily even when charging and discharging is performed, and which also has excellent structural efficiency. The thickness of the protective layer may be 0.1 μm to 2.0 μm, may be 0.5 μm to 1.5 μm, or may be 0.5 μm to 1.2 μm. The “thickness of the protective layer” refers to the thickness of the protective layer on one side, when the protective layer is formed on both sides of the substrate. The thickness of the protective layer was measured by the same measurement method as that described in the Examples.

### (1.3) Resin Coating Layer

The current collector of the present disclosure may further include a resin coating layer on the protective layer. This improves the adhesion between the current collector and the electrode active material layer. The resin coating layer may contain a resin and a conductive aid. Examples of the resin include vinyl-based resins (e.g., polyvinyl chloride, polyvinyl acetate, polyvinyl alcohol, and so forth) and fluorine-based resins (e.g., polyvinylidene fluoride, polytetrafluoroethylene, and so forth), and so forth. Examples of the conductive aid include carbon materials (e.g., vapor grown carbon fiber, acetylene black, and so forth) and metal materials (nickel, aluminum, stainless steel, and so forth).

### (2) Battery

The battery of the present disclosure has, in this order, the current collector according to the present disclosure (hereinafter also referred to as “anode current collector”), an anode active material layer, an electrolyte layer, a cathode active material layer, and a cathode current collector. The electrode active material layer is the anode active material layer. Reaction potential (vs. Li+/Li) of the anode active material that is contained in the anode active material layer is 0.3 V or less.

The term “anode active material layer” refers to a layer containing an anode active material. The term “cathode active material” refers to a layer containing a cathode active material. The term “electrolyte layer” refers to a layer that is interposed between the cathode active material layer and the anode active material layer and that contains an electrolyte that conducts carrier ions (i.e., lithium ions).

The battery according to the present disclosure has the above configuration, and accordingly less readily exhibits increase in resistance even when charged and discharged, and has excellent structural efficiency.

The battery according to the present disclosure may have at least one power generating unit. The power generating unit has, in this order, an anode current collector, an anode active material layer, an electrolyte layer, a cathode active material layer, and a cathode current collector. When the battery according to the present disclosure includes a plurality of power generating units, the power generating units may be connected in parallel, or may be connected in series.

### (2.1) Anode Active Material Layer

The anode active material layer contains an anode active material having a reaction potential (vs. Li+/Li) of 0.3 V or lower, and may further contain at least one of a solid electrolyte, a conductive material, and a binder, as necessary. The anode active material layer is formed on at least one of the principal faces of the anode current collector.

Examples of the anode active material that has a reaction potential (vs. Li+/Li) of 0.3 V or less include an active material containing elemental Si, a carbon material, and so forth. Examples of active materials containing elemental Si include silicon itself, silicon alloys (e.g., alloys of Si and one or more metals selected from a group consisting of Sn, Ti, Fe, Ni, Cu, Co, Al, and so forth), porous silicon, silicon clathrate compounds, silicon oxides, and so forth. Examples of the carbon material include graphite materials, amorphous carbon materials, carbon black, activated carbon, and so forth.

Examples of the solid electrolyte include sulfide-based solid electrolytes (e.g., Li₂S—P₂S₅, or the like), oxide-based solid electrolytes, nitride-based solid electrolytes, halide-based solid electrolytes, and so forth. Examples of the conductive material include carbon materials (e.g., acetylene black, Ketjen black, vapor grown carbon fiber (VGCF) and so forth), metal particles, and conductive polymers, and examples of the binder include fluoride-based binders (e.g., polyvinylidene fluoride (PVDF) and so forth), polyimide-based binders, and rubber-based binders (e.g., acrylonitrile butadiene rubber (ABR)-based binders and so forth).

### (2.2) Electrolyte Layer

The electrolyte layer includes an electrolyte. Specific examples of the electrolyte include solid electrolytes, non-aqueous electrolytic solutions containing lithium salts (e.g., LiPF₆ or the like), non-aqueous gel electrolytic solutions, ion-conductive polymers, and so forth. The electrolyte layer may be a known electrolyte layer. The electrolyte layer preferably contains a solid electrolyte.

When the electrolyte layer contains a solid electrolyte, the electrolyte layer (hereinafter also referred to as “solid electrolyte layer”) may further contain a binder, as necessary. Examples of the solid electrolyte and the binder include the same solid electrolyte and binder as those exemplified as the solid electrolyte and binder that can be contained in the anode active material layer.

When the electrolyte layer contains a non-aqueous electrolytic solution, the electrolyte layer has a separator. The separator maintains a gap between the cathode active material layer and the anode active material layer to suppress occurrence of contact short-circuiting, and also to allow lithium ions to pass through. Examples of the separator include a porous resin sheet and a nonwoven fabric. Examples of the material for the porous resin sheet include polyolefins (polypropylene, polyethylene, and so forth), and so forth. Examples of materials for the nonwoven fabric include polypropylene, polyethylene terephthalate, methyl cellulose, and so forth.

### (2.3) Cathode Active Material Layer

The cathode active material layer contains a cathode active material, and may further contain at least one of a solid electrolyte, a conductive material, and a binder, as necessary. The cathode active material layer is formed on at least one of the principal faces of the cathode current collector.

Examples of the cathode active material include oxide active materials and so forth. Examples of the oxide active material include layered rock-salt active materials (e.g., LiNi_{0.80}Co_{0.15}Al_{0.05}O₂, LiNi_{1/3}Co_{1/3}Mn_{1/3}O₂, LiCoO₂, and so forth), spinel active materials (e.g., LiMn₂O₄, Li₄Ti₅O₁₂, and so forth), olivine active materials (e.g., LiFePO₄, LiMnPO₄, and so forth), and so forth.

Examples of the solid electrolyte, the conductive material, and the binder include the same solid electrolyte, conductive material, and binder as those exemplified as the solid electrolyte, conductive material, and binder that can be contained in the anode active material layer.

### (2.4) Cathode Current Collector

The cathode current collector is a layer that collects current from the cathode active material layer. The cathode current collector may be a sheet-like object. Examples of the material for the cathode current collector include stainless steel, aluminum, nickel, iron, titanium, and carbon.

### (2.5) Casing

The battery according to the present disclosure typically includes a casing. The casing accommodates the anode current collector, the anode active material layer, the electrolyte layer, the cathode active material layer, and the cathode current collector. Examples of the casing include a laminate casing, a metal can, and so forth.

### (2.6) Embodiments

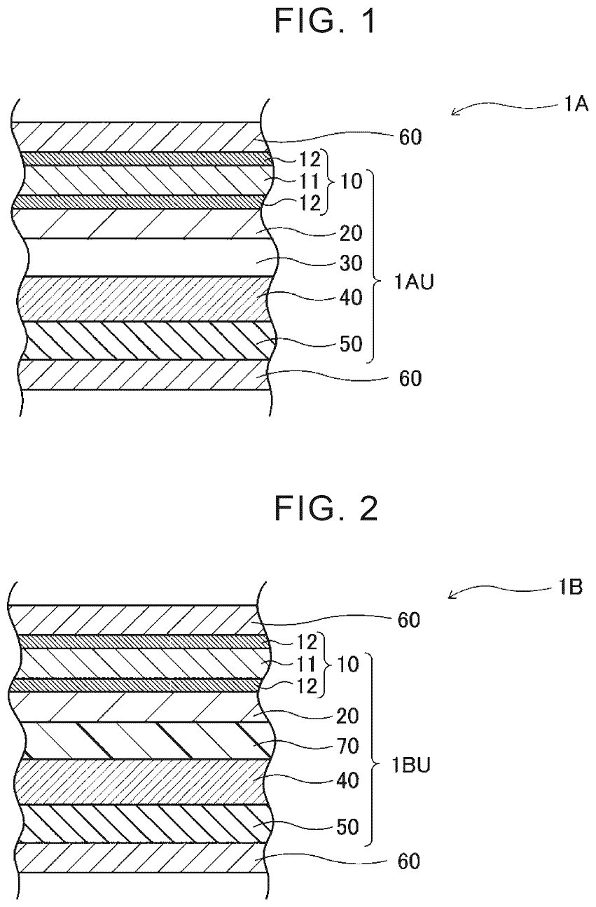

A battery 1A according to a first embodiment of the present disclosure has one power generating unit 1AU and a casing 60, as illustrated in FIG. 1. The casing 60 accommodates the power generating unit 1AU. The power generating unit 1AU includes an anode current collector 10, an anode active material layer 20, a solid electrolyte layer 30, a cathode active material layer 40, and a cathode current collector 50, which are laminated in this order. The anode current collector 10 includes a substrate 11 and protective layers 12 that are formed on both principal faces of the substrate 11. The substrate 11 contains elemental Al. The substrate 11 has a breaking tensile strength of 200 MPa or higher. Reaction potential (vs. Li+/Li) of the anode active material that is contained in the anode active material layer 20 is 0.3 V or lower.

A battery 1B according to a second embodiment of the present disclosure has one power generating unit 1BU, a non-aqueous electrolytic solution (omitted from illustration), and the casing 60, as illustrated in FIG. 2. The casing 60 accommodates the power generating unit 1BU and the non-aqueous electrolytic solution. The power generating unit 1BU has the anode current collector 10, the anode active material layer 20, a separator 70, the cathode active material layer 40, and the cathode current collector 50, laminated in this order. The anode current collector 10 includes the substrate 11 and the protective layers 12 that are formed on both of the principal faces of the substrate 11. The substrate 11 contains elemental Al. The substrate 11 has a breaking tensile strength of 200 MPa or higher. Reaction potential (vs. Li+/Li) of the anode active material that is contained in the anode active material layer 20 is 0.3 V or lower.

Hereinafter, embodiments of the present disclosure will be described with reference to Examples. Note, however, that the present disclosure is not limited to these Examples.

### 1. Examples and Comparative Examples

### 1.1 Comparative Example 4

A current collector made of a substrate (alloy number A3003, thickness 15 μm) was prepared.

Using a Thompson blade that was molded into a dumbbell-shaped No. 6 shape as described in JIS K6251, a substrate (alloy number A3003, thickness 15 μm) was punched into a test piece that was dumbbell-shaped. Both ends of the test piece were attached to a tensile tester. The tensile tester pulled the test piece at a pulling speed of 2 mm/min until it broke. The measured value of the breaking tensile strength of the test piece was taken as the “breaking tensile strength of substrate”. The breaking tensile strength of Comparative Example 4 was 243 MPa.

### 1.2 Comparative Example 5

A current collector that was made of a substrate (alloy number A1N30, thickness 15 μm) was prepared.

The breaking tensile strength of the test piece was measured in the same manner as in Comparative Example 4, except that the substrate was changed to a substrate (alloy number A1N30, thickness 15 μm). The breaking tensile strength of Comparative Example 5 was 180 MPa.

### 1.3 Example 1

A current collector was prepared, which had a substrate (alloy number A3003, thickness 15 μm) and protective layers (material of electrolytic Ni plated film, thickness per side of 1.0 μm) that were formed on both sides of the substrate. The substrate of Example 1 was the same as the substrate of Comparative Example 4. The breaking tensile strength of Example 1 was 243 MPa.

### 1.4 Example 2

A current collector was prepared, which had a substrate (alloy number A3003, thickness 15 μm) and protective layers (material of electrolytic Ni plated film, thickness per side of 1.4 μm) that were formed on both of the sides of the substrate. The substrate of Example 2 was the same as the substrate of Comparative Example 4. The breaking tensile strength of Example 2 was 243 MPa.

### 1.5 Comparative Example 1

A current collector was prepared, which had a substrate (alloy number A1N30, thickness 15 μm) and protective layers (material of electrolytic Ni plated film, thickness per side of 1.2 μm) that were formed on both sides of the substrate. The substrate of Comparative Example 1 was the same as the substrate of Comparative Example 5. The breaking tensile strength of Comparative Example 1 was 180 MPa.

### 1.6 Comparative Example 2

A current collector was prepared, which had a substrate (alloy number A1N30, thickness 15 μm) and protective layers (material of electrolytic Ni plated film, thickness per side of 1.6 μm) that were formed on both of the sides of the substrate. The substrate of Comparative Example 2 was the same as the substrate of Comparative Example 5. The breaking tensile strength of Comparative Example 2 was 180 MPa.

### 1.7 Comparative Example 3

A current collector was prepared, which had a substrate (alloy number A1N30, thickness 15 μm) and protective layers (material of electrolytic Ni plated film, thickness per side of 2.2 μm) that were formed on both of the sides of the substrate. The substrate of Comparative Example 3 was the same as the substrate of Comparative Example 5. The breaking tensile strength of Comparative Example 3 was 180 MPa.

### 2. Measurement Method

### 2.1 Thickness of Protective Layer

The current collector was subjected to cross-sectional processing using a cross section polisher (CP) to obtain a test piece. The thickness of the protective layer was measured using a scanning electron microscope (SEM) image of the test piece. The measured value of the thickness of the protective layer was taken as “thickness of protective layer”.

### 2.2 Breaking Tensile Strength of Current Collector (%)

The current collector was punched into a test piece that was dumbbell shaped. Both ends of the test piece were attached to a tensile tester. The tensile tester pulled the test piece at a pulling speed of 2 mm/min until it broke. The breaking tensile strength of the test piece was measured.

In accordance with the following Expression (i), with the measured value of breaking tensile strength of the test piece of Comparative Example 1 as 100, the relative values of the measured values of breaking tensile strength of the test pieces of each of the Examples were defined as “breaking tensile strength of current collector (%)”.

$$Breaking tensile strength of current collector ( \% ) = ( measured value of breaking tensile strength of test pieces of each Example / measured value of breaking tensile strength of test piece of Comparative Example 1 ) \times 100 \qquad Expression ( i )$$

Regarding Comparative Example 4 and Comparative Example 5, the breaking tensile strength of the substrate was divided by the thickness of the substrate measured with a film thickness gauge to obtain a calculated value, which was taken as “measured value of breaking tensile strength of test piece”, and the breaking tensile strength (%) of the current collector was thus found.

### 2.3 Current Collector Stiffness (%)

A stiffness value of each example was calculated according to the following Expression (ii). The Young's modulus of aluminum and the Young's modulus of nickel were taken from a metal physical property table.

$$Stiffness value = film thickness of substrate \times Young ' s modulus of Al ( 68 GPa ) + film thickness of protective layer ( Ni plated film ) \times Young ' s modulus of Ni ( 204 GPa ) \qquad Expression ( ii )$$

With the stiffness value of Comparative Example 1 as 100, the relative value of the stiffness value of each Example was calculated as “stiffness (%)”, in accordance with the following Expression (iii).

$$Stiffness ( \% ) = ( Calculated value of stiffness of each example / Calculated value of stiffness of Comparative Example 1 ) \times 100 \qquad Expression ( iii )$$

### 2.4 Battery Resistance

A battery laminate was produced using the current collector as described below, and the battery resistance was measured.

### 2.4.1 Solid Electrolyte Layer

A slurry containing a sulfide-based solid electrolyte (SE) (SE:Li₂S—P₂S₅), an acrylonitrile butadiene rubber (ABR)-based binder, heptane, and butyl butyrate, was stirred with an ultrasonic dispersing device. The mass ratio (SE:ABR binder) was adjusted to 99.4:0.6. Thus, an SE slurry was obtained. This SE slurry was applied onto a stainless steel (SUS) foil by the doctor blade method, dried on a hot plate at 50° C. for 1 minute, and further dried on a hot plate at 150° C. for 30 minutes. As a result, a solid electrolyte layer with stainless steel foil attached was obtained. The solid electrolyte layer with stainless steel foil attached has stainless steel foil, and a solid electrolyte layer that is formed on the stainless steel foil.

### 2.4.2 Cathode

A slurry containing a cathode active material (LiNi_{0.80}Co_{0.15}Al_{0.05}O₂, i.e. lithium nickel cobalt aluminum oxide (NCA)), a sulfide-based solid electrolyte (SE: Li₂S—P₂S₅), vapor grown carbon fiber (VGCF), a polyvinylidene fluoride (PVdF)-based binder, and butyl butyrate, was stirred with an ultrasonic dispersing device. The mass ratio (NCA:SE:VGCF:PVdF-based binder) was adjusted to be 78.3:18.8:2.9:2.8. A cathode slurry was thus obtained. This cathode slurry was applied onto an aluminum (Al) foil by the doctor blade method, dried on a hot plate at 50° C. for 20 minutes, and further dried on a hot plate at 150° C. for 30 minutes. A cathode was thus obtained. The cathode had a cathode current collector (Al foil) and a cathode active material layer that was formed on the cathode current collector.

### 2.4.3 Anode

A vinyl-based resin and carbon were mixed, and then a solvent was further mixed in to obtain a resin slurry. The mass ratio (vinyl-based resin:carbon) was adjusted to be 4:1. The resin slurry was applied to the above current collectors (current collectors of Example 1 and Example 2, and Comparative Examples 1 to 5) by the doctor blade method, dried on a hot plate at 50° C. for 20 minutes, and further dried on a hot plate at 150° C. for 30 minutes. As a result, a current collector with a resin coating layer attached was obtained. Note that the resistance of the film that was formed from the resin slurry alone was measured by four-terminal sensing, and the measured value of resistance was found to be 10 Ω·cm.

A slurry containing an anode active material (silicon), a sulfide-based solid electrolyte (SE: Li₂S—P₂S₅), vapor grown carbon fiber (VGCF), a polyvinylidene fluoride (PVdF)-based binder, and butyl butyrate, was stirred with an ultrasonic dispersing device. An anode slurry was thus obtained. The mass ratio (silicon:SE:VGCF:PVdF-based binder) was adjusted to be 49.0:41.2:7.5:6.6. The anode slurry was applied onto a resin-coated current collector by the doctor blade method, dried on a hot plate at 50° C. for 20 minutes, and further dried on a hot plate at 150° C. for 30 minutes. An anode was thus obtained. The anode had an anode current collector (current collector with resin coating layer attached) and an anode active material layer that was formed on the anode current collector.

### 2.4.4 Electrode Laminate

The anode and the stainless steel foil-attached solid electrolyte layer were laminated such that the anode active material layer and the solid electrolyte layer were in contact with each other, thereby obtaining a first laminate. The laminate was pressed with a roll press at a pressure of 50 kN/cm and a temperature of 160° C. The stainless steel foil was peeled off from the laminate that was pressed to obtain an anode laminate. Further, the anode laminate and the stainless steel foil-attached solid electrolyte layer were laminated such that the solid electrolytes were in contact with each other to obtain a second laminate. The second laminate was pre-pressed in a flat uniaxial press at a pressure of 100 MPa and a temperature of 25° C. The stainless steel foil was peeled off from the second laminate after the preliminary pressing, which was then punched out to a size of 1.08 cm². Thus, an anode laminate with a solid electrolyte layer attached was obtained.

The cathode and the solid electrolyte layer with stainless steel foil attached were laminated such that the cathode active material layer and the solid electrolyte layer were in contact with each other, thereby obtaining a laminate. The laminate was pressed with a roll press at a pressure of 50 kN/cm and a temperature of 160° C. The stainless steel foil was peeled off from the laminate after the pressing, and the laminate was punched out to a size of 1 cm². Thus, a cathode laminate was obtained.

The cathode laminate, and the anode laminate with a solid electrolyte layer attached, were laminated such that the solid electrolyte layers were in contact with each other, thereby obtaining a laminate. This laminate was pressed in a flat uniaxial press at a pressure of 500 MPa and a temperature of 160° C. to obtain a battery laminate.

### 2.4.5 Initial Charge and Discharge

The battery laminate was sandwiched between two restraining plates. The two restraining plates were fastened with a fastener at a restraining pressure of 1 MPa to fix the distance between the two restraining plates. Thus, a battery laminate with restraining plates attached was obtained. The battery laminate with restraining plates was subjected to constant current charging at 1/10 C, up to 4.05 V, then constant voltage charging at 4.05 V up to a final current of 1/100 C, then constant current discharging at 1/10 C up to 2.5 V, and then constant voltage discharging at 2.5 V up to a final current of 1/100 C.

2.4.6 Battery Resistance (%)

The battery was charged at a constant current of ⅓ C up to 4.05 V, then charged at a constant voltage of 1/100 C, then discharged at a constant current of ⅓ C to 3.29 V, and then the State of Charge (SOC) was adjusted at 1/100 C. After adjusting the SOC, constant current discharge was performed at 6 C for 5 seconds. The battery resistance was calculated from the amount of voltage drop at that time.

With the calculated value of the battery resistance of Comparative Example 1 as 100, the relative value of the calculated value of the battery resistance of each Example was calculated as “battery resistance (%)”, in accordance with the following Expression (iv).

Acceptable battery resistance (%) is 90% or lower.

$$Battery resistance ( \% ) = ( calculated value of battery resistance of each Example / calculated value of battery resistance of Comparative Example 1 ) \times 100 \qquad Expression ( iv )$$

2.4.7 Current Collector Thickness with Respect to Battery Resistance (%)

The thickness of the current collector relative to the battery resistance was calculated regrading Example 1, Example 2, and Comparative Example 3, in which the battery resistance (%) was 90% or lower. With the calculated value of the thickness of the current collector relative to the battery resistance in Comparative Example 3 as 100, the relative value of the calculated value of thickness of the current collector relative to the battery resistance in each Example was defined as “thickness of current collector relative to battery resistance (%)”, in accordance with the following Expression (v). The lower the thickness of the current collector relative to the battery resistance (%) is, the more efficient the current collector can make the battery structure to be. Thickness of the current collector relative to the battery resistance (%) that is acceptable is 99% or lower.

$$Thickness of current collector relative to battery resistance ( \% ) = ( Calculated value of thickness of current collector relative to battery resistance in each Example / Calculated value of thickness of current collector relative to battery resistance in Comparative Example 3 ) \times 100 \qquad Expression ( v )$$

TABLE 1

| | | | | | | | | Evaluation | |
|---|---|---|---|---|---|---|---|---|---|
| | | | | | | | | | Thickness |
| | | | | | | | | | of current |
| | Current Collector | | | | | | | | collector |
| | Substrate | | | | | | | | with |
| | | | Breaking | Protective layer | | Breaking | | | respect to |
| | Alloy | | tensile | | Thickness | tensile | | Battery | battery |
| | number | Thickness | strength | Material | per side | strength | Stiffness | Resistance | resistance |
| | — | μm | MPa | — | μm | % | % | % | % |
| Comparative | A1N30 | 15 | 180 | Electrolytic | 1.2 | 100 | 100 | 100 | — |
| Example 1 | | | | Ni plated | | | | | |
| Comparative | A1N30 | 15 | 180 | Electrolytic | 1.6 | 181 | 111 | 91 | — |
| Example 2 | | | | Ni plated | | | | | |
| Comparative | A1N30 | 15 | 180 | Electrolytic | 2.2 | 206 | 131 | 87 | 100 |
| Example 3 | | | | Ni plated | | | | | |
| Comparative | A3003 | 15 | 243 | — | 0 | 100 | 75 | 116 | — |
| Example 4 | | | | | | | | | |
| Comparative | A1N30 | 15 | 180 | — | 0 | 131 | 150 | 114 | — |
| Example 5 | | | | | | | | | |
| Example 1 | A3003 | 15 | 243 | Electrolytic | 1.0 | 178 | 94 | 87 | 77 |
| | | | | Ni plated | | | | | |
| Example 2 | A3003 | 15 | 243 | Electrolytic | 1.4 | 194 | 105 | 87 | 85 |
| | | | | Ni plated | | | | | |

In Comparative Example 1 to Comparative Example 3, the current collector had a substrate containing elemental Al and a protective layer. The strength of the substrate was not 200 MPa or higher. Accordingly, in Comparative Example 1 and Comparative Example 2, the battery resistance (%) was not 90% or lower. In Comparative Example 3, the battery resistance (%) was 90% or lower, but the thickness of the current collector (%) relative to the battery resistance was not 99% or lower.

In Comparative Example 4 and Comparative Example 5, the current collector was not provided with a protective layer. Accordingly, in Comparative Example 4 and Comparative Example 5, the battery resistance (%) was not 90% or lower.

As a result, it was found that the current collectors of Comparative Examples 1 to 5 were not “current collectors by which a battery can be made in which the resistance increases less readily even when charging and discharging is performed, and which also has excellent structural efficiency”.

In Example 1 and Example 2, the current collector had a substrate containing elemental Al and a protective layer. The strength of the substrate was 200 MPa or higher. Accordingly, in Example 1 and Example 2, the battery resistance (%) was 90% or lower, but the thickness (%) of the current collector relative to the battery resistance was 99% or lower. As a result, it was found that the current collectors of Example 1 and Example 2 are “current collectors by which a battery can be made in which the resistance increases less readily even when charging and discharging is performed, and which also has excellent structural efficiency”.

What is claimed is:

1. A current collector, comprising:
a substrate containing elemental aluminum; and
a protective layer that is fashioned on a side of the substrate that is in contact with an electrode active material layer, wherein
a breaking tensile strength of the substrate is 200 MPa or higher.

2. The current collector according to claim 1, wherein the protective layer contains elemental nickel.

3. The current collector according to claim 2, wherein a thickness of the protective layer is 2.0 μm or less.

4. A battery, comprising:
the current collector according to claim 1; an anode active material layer; an electrolyte layer; a cathode active material layer; and a cathode current collector, in this order, wherein
the electrode active material layer is the anode active material layer, and
reaction potential (vs. Li+/Li) of an anode active material that is contained in the anode active material layer is 0.3 V or lower.

5. The battery according to claim 4, wherein the electrolyte layer contains a solid electrolyte.
